(19) United States
(12) Patent Application Publication
(10) Pub. No.: US 2010/0177473 A1
(43) Pub. Date: Jul. 15, 2010

(54) COMPUTER DEVICE

(75) Inventors: Hsieh-Fa WU, Xindian City (TW); Chiu-Ming Hsu, Taipei (TW)

Correspondence Address: ROGER H. CHU, 19499 ERIC DRIVE, SARATOGA, CA, 95070, US

(73) Assignee: ADVANPOS TECHNOLOGY CO. LTD., Xindian City (TW)

(21) Appl. No.: 12/730,837

(22) Filed: Mar. 24, 2010

Related U.S. Application Data
(63) Continuation-in-part of application No. 12/183,938, filed on Jul. 31, 2008.

(51) Int. Cl. G06F 1/16

(52) U.S. Cl. 361/679.21

(57) ABSTRACT

The present invention is related to an improved computer device, which comprises: a housing, a transmission interface unit, a removable host, a first connection mechanism, and a touchable display unit, wherein the transmission interface unit is disposed in an accommodation portion of the housing; the removable host is disposed in the accommodation portion and comprises a host case, a plurality of electronic devices and a pull rod; the first connection mechanism is disposed on the housing to assist connecting the removable host and the touchable display unit; moreover, a plurality of expansion ports are disposed on the sides of the touchable display unit, the expansion ports are used to respectively connect an electronic device for increasing functions.

### CROSS-REFERENCE TO RELATED APPLICATION

This application is a continuation-in-part of a co-pending U.S. patent application Ser. No. 12/183,938 for “ONE-PIECE LC TYPE OPTICAL FIBER ADAPTER” filed Jul. 31, 2008. The content of which is incorporated by reference in its entirety.

### BACKGROUND OF THE INVENTION

1. Technical Field

The present invention relates to a computer device, and more particularly, to an improved computer device with a modularized display and a modularized host so as to facilitate the assembly, the maintenance and the function expansion thereof

2. Description of Related Art

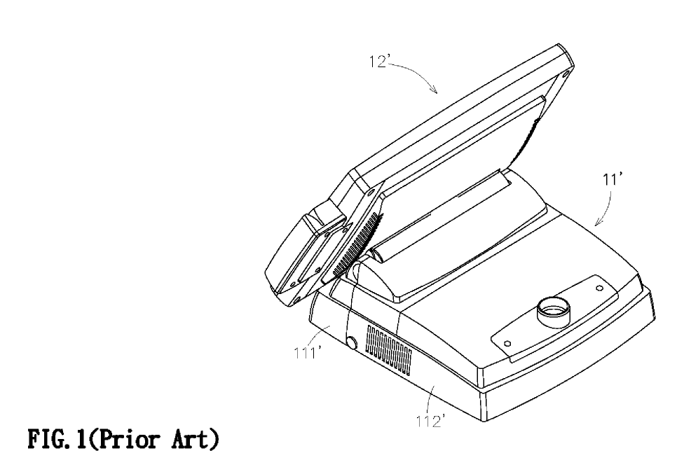

Referring to FIG. 1, which illustrates a stereogram of a conventional point of sales (POS) device, generally speaking, the conventional POS device includes: a housing 11′, which has a processing system; a display 12′, which is disposed on the housing 11′, wherein the display 12′ is usually a touchable display, so that the processing system computes the processes after a user directly executes sale operations on the display 12′, and then the display 12′ shows the process results.

As shown in FIG. 1, the process system is disposed in a closure space of the housing 11′ according to the conventional POS device 1′, so that the display 12′ should be dismounted from the housing 11′ by tools when the process system has failed, further that, the tools are continuously operated to dismantle the screwing bolts on the housing 11′ for disassembling the case and the panel of the housing, and therefore the system just can be repaired.

Besides, the structure of the conventional POS device 1′ is not modularized, so that the whole conventional POS device 1′ must be dismounted by way of complex dismantling procedures in order to maintain one or some of the devices within the housing 11′ and repair the failed devices. Such dismantling procedures cause exceeding use of human labor and repairing time. Moreover, the display 12′ is merely combined with the housing 11′ to form the conventional POS device 1′ due to their non-modular structure, in addition, the devices and the functions of the display 12′ and the housing 11′ are difficult to be expanded, for example, to expansively equipped a small display with the housing 11′ for showing product information or add a wireless transmission device on the display 12′. That is, such prior art is lack of expansions due to that the prior structure is not modularized.

Accordingly, in view of the shortcomings of the conventional POS device, the inventor of the present invention has made great efforts to make improvement thereof and finally provides an improved computer device.

### SUMMARY OF THE INVENTION

The primary objective of the present invention is to provide an improved computer device, which comprises a modular removable host and a modular touchable display unit, the removable host and the touchable display unit are capable of being assembled and disassembled so as to facilitate that the maintenance and the function expansion of the electronic devices within the removable host and the touchable display unit.

Another objective of the present invention is to provide an improved computer device, which comprises a modular removable host and a modular touchable display unit, the removable host and the touchable display unit are capable of being assembled and disassembled so as to facilitate that the maintenance and the function expansion of the electronic devices within the removable host and the touchable display unit.

To accomplish the primary objective described above, an improved computer device is provided and comprises:

a housing, which has an accommodation portion, the bottom surface of the accommodation portion has a lockhole;

a transmission interface unit, which is disposed in the accommodation portion to assist transmitting signal, moreover, the transmission interface unit has a host-connecting port and at least one display-connecting port;

a removable host, which is disposed in the accommodation portion and comprises: a host case with a base and a cover, wherein the cover is used to shelter the base; a plurality of electronic devices, which are disposed on the base and constitute a computing system for processing, the electronic devices have a first connection portion, wherein the first connection portion inserts into the host-connecting port when the removable host is placed into the accommodation portion; and a pull rod, which is pivotally connected to the host case, so that the host case can be drawn from the accommodation portion through the pull rod;

a first connection mechanism, which is disposed on the housing and has a first connection card; and

a touchable display unit, which is connected to the first connection mechanism and has a second connection portion for connecting to the first connection card, so that the touchable display unit electrically connects to the removable host through the transmission interface unit, moreover, a plurality of expansion ports are disposed on the sides of the touchable display unit for respectively connecting to an electronic device for increasing functions.

Also, to accomplish another objective described above, an improved computer device is provided and comprises:

a housing, which has an accommodation portion;

a transmission interface unit, which is disposed in the accommodation port so as to assist transmitting signal and has a host-connecting port and at least one display-connecting port;

a removable host, which is disposed in the accommodation portion and comprises: a host case having a base and a cover, wherein the cover is used to shelter the base; a plurality of electronic devices, which are disposed on the base and constitute a computing system for processing, the electronic devices have a first connection portion, wherein the first connection inserts into the host-connecting port when the removable host is placed into the accommodation portion; and a pull rod, which is pivotally connected to the host case, so that the host case is able to be drawn from the accommodation portion via the pull rod;

a first connection mechanism, which is disposed on the housing and has a first connection card;

a first touchable display unit, which is connected to the first connection mechanism, wherein the first touchable display unit has a second connection portion for connecting the first connection card, so that the first touchable display unit is able to electrically connect to the removable host through the transmission interface unit, moreover, a plurality of first expansion ports are disposed on the sides of the first touchable display unit for respectively connecting to an electronic device for increasing functions;

a second connection mechanism, which is disposed on the housing and has a second connection card; and

a second touchable display unit, which is connected to the second connection mechanism, wherein the second touchable display unit has a third connection portion for connecting to the second connection card, so that the second touchable display unit is able to electrically connect to the removable host through the transmission interface unit, moreover, a plurality of second expansion ports are disposed on the sides of the second touchable display unit, the expansion ports are used to respectively connect to the electronic device for increasing functions.

BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereogram of a conventional point of sales (POS) device;

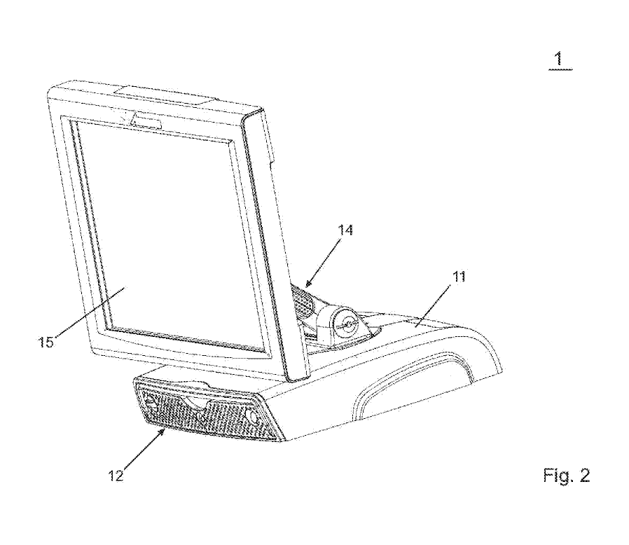

FIG. 2 is the stereo view of an improved computer device according to present invention;

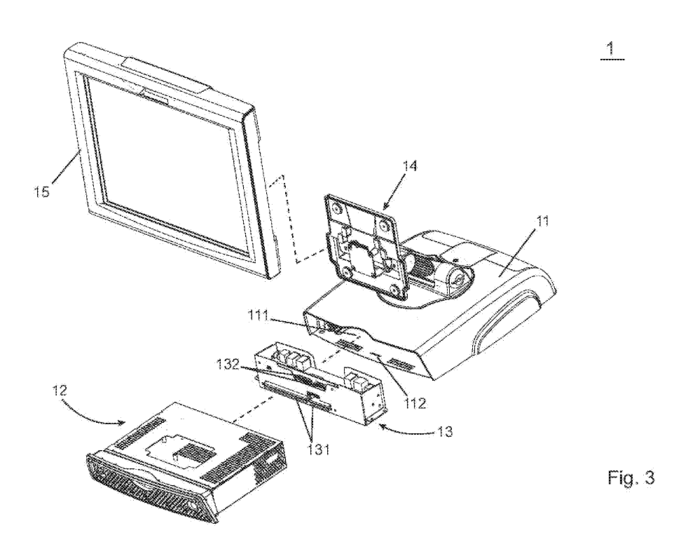

FIG. 3 is an exploded view of the improved computer device according to present invention;

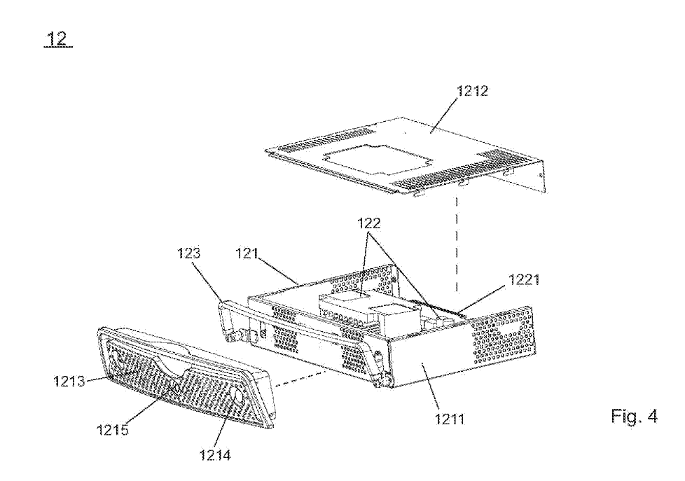

FIG. 4 is the exploded view of a removable host of the improved computer device;

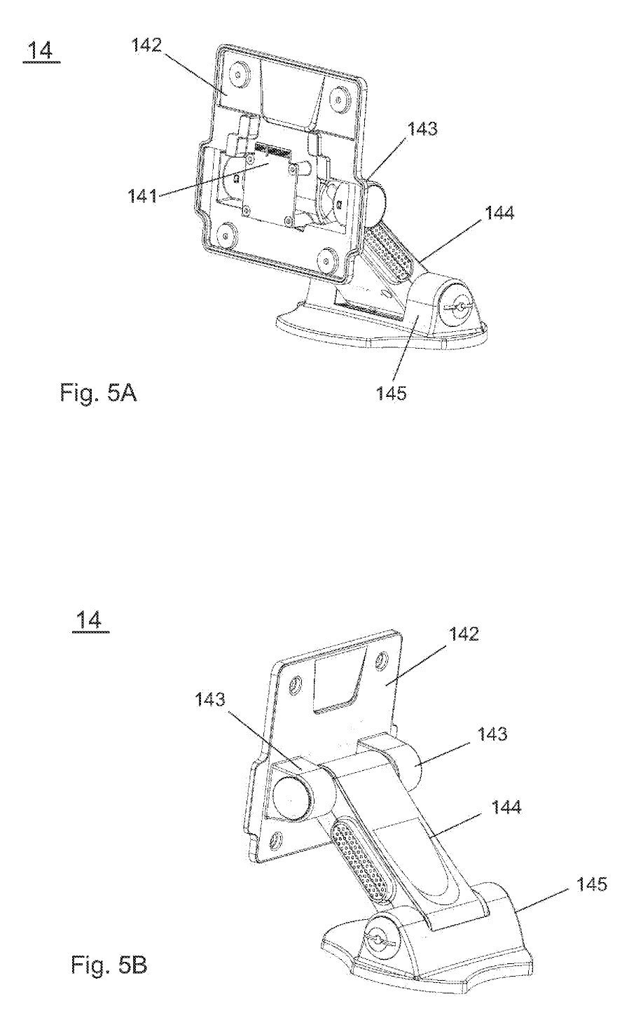

FIGS. 5A and 5B are the stereo view of a first connection mechanism of the improved computer device;

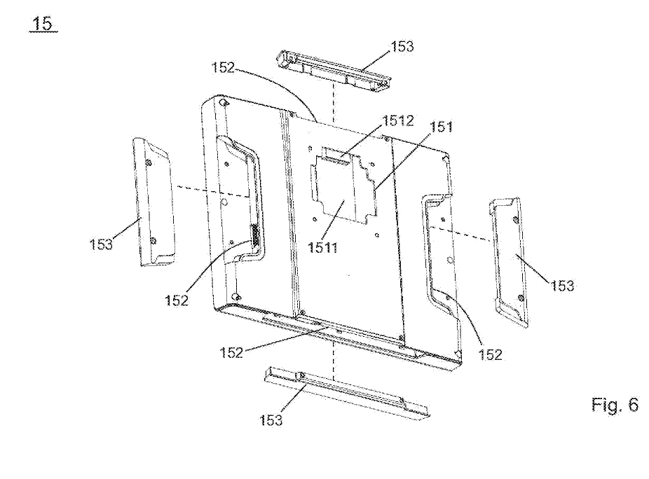

FIG. 6 is the stereo view of a touchable display unit of the improved computer device;

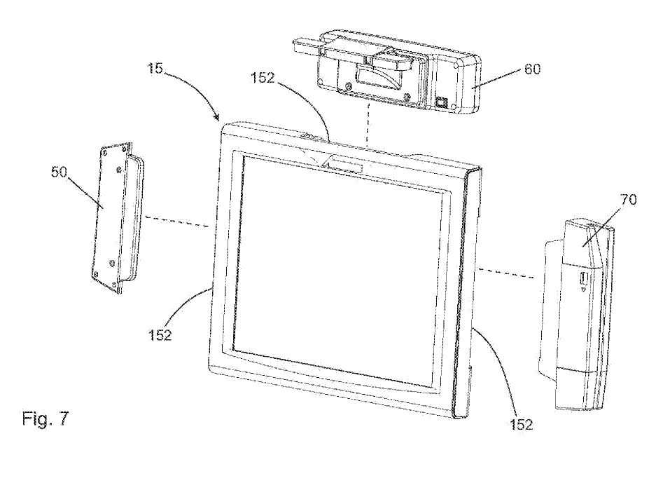

FIG. 7 is the another stereo view of the touchable display unit of the improved computer device;

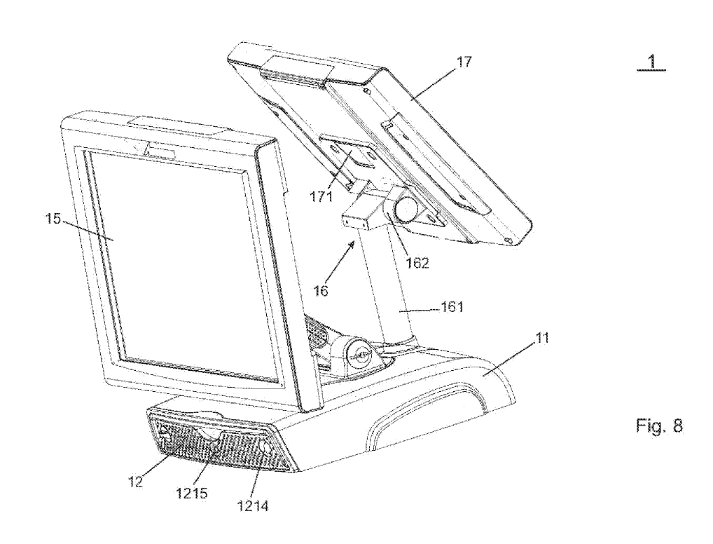

FIG. 8 is the stereo view of the improved computer device with two displays;

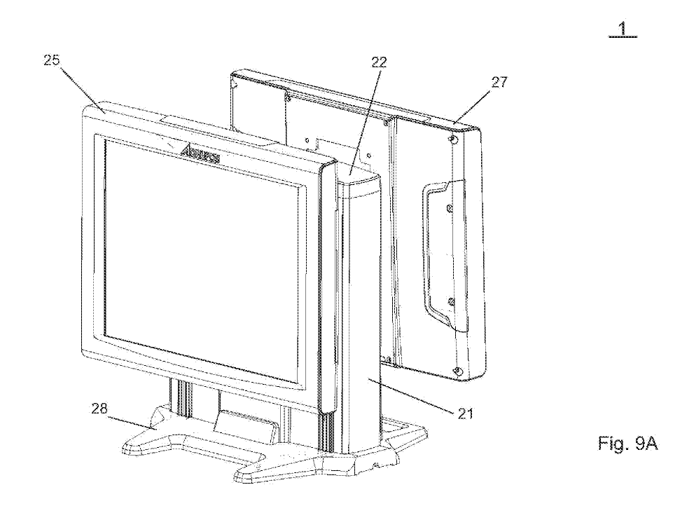

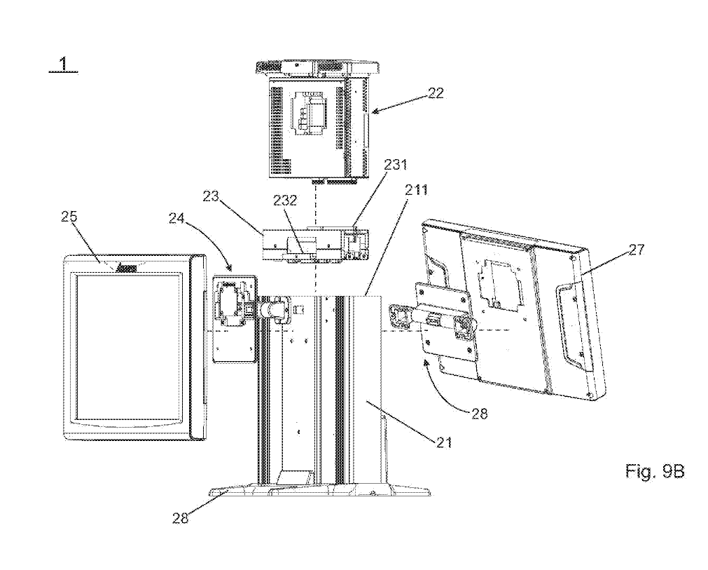

FIG. 9A is the stereo view of a second embodiment of the improved computer device according to present invention;

FIG. 9B is the exploded view of the second embodiment of the improved computer device according to present invention;

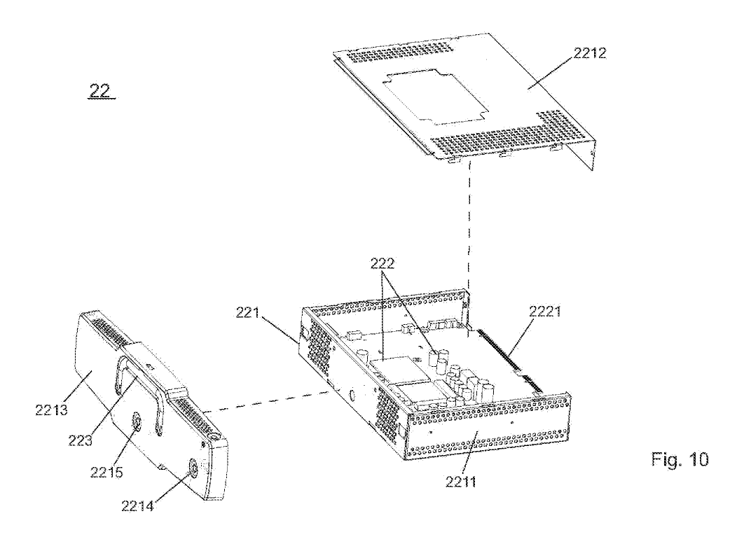

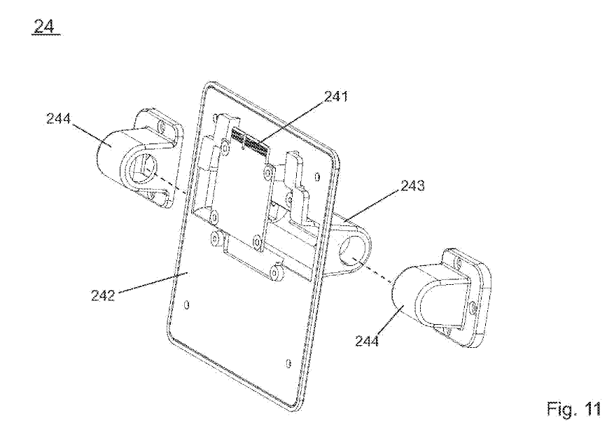

FIG. 10 is the exploded view of the removable host of the second embodiment of the improved computer device;

FIG. 11 is the exploded view of the first connection mechanism of the second embodiment of the improved computer device;

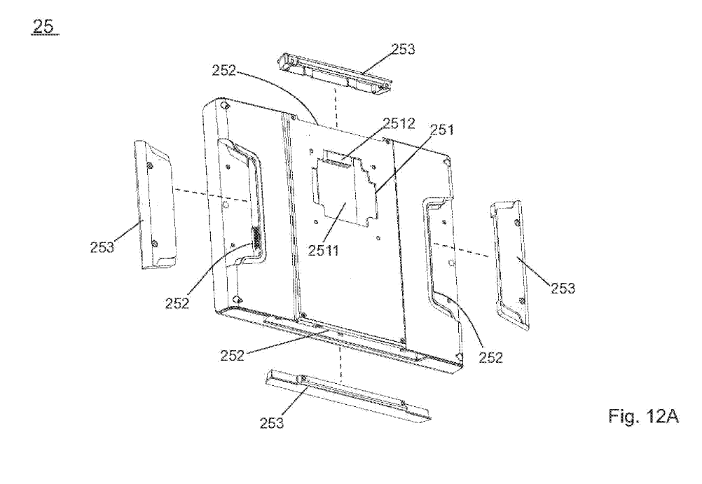

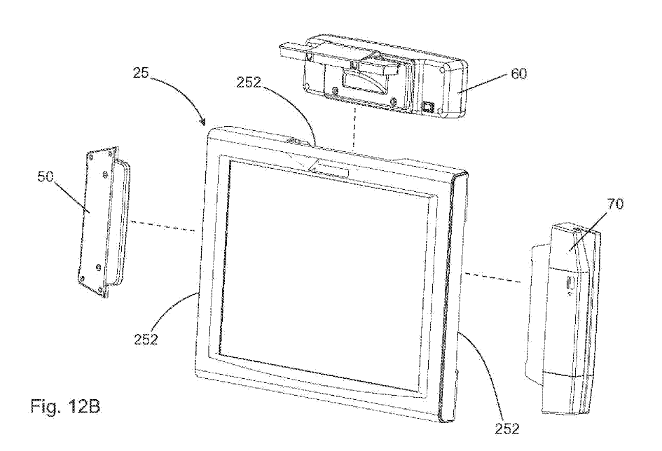

FIGS. 12A and 12B are the stereo view of a first touchable display unit of the second embodiment of the improved computer device;

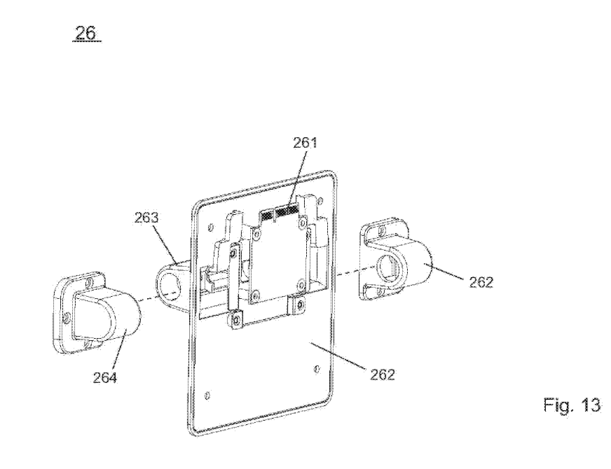

FIG. 13 is the exploded view of a second connection mechanism of the second embodiment of the improved computer device; and

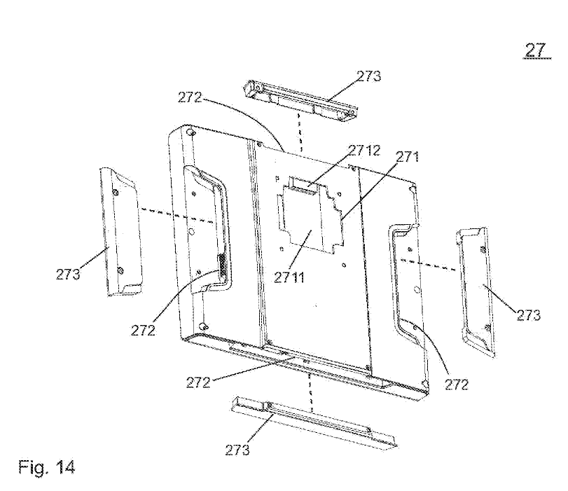

FIG. 14 is the stereo view of a second touchable display unit of the second embodiment of the improved computer device.

### DETAILED DESCRIPTION OF THE INVENTION

To explain the improved computer device of the present invention more clearly, detailed description will be made hereinbelow with reference to the attached drawings.

Referring to FIGS. 2 and 3, which respectively illustrate a stereo view and an exploded view of the improved computer device according to present invention, the improved computer device 1 includes: a housing 11, a transmission interface unit 13, a removable host 12, a first connection mechanism 14, and a touchable display unit 15. The housing 11 has an accommodation portion 111, and a lockhole 112 is disposed on the bottom surface of the accommodation portion 111. The transmission interface unit 13 is disposed in the accommodation portion 111 to assist transmitting signal; moreover, the transmission interface unit 13 has a host-connecting port 131 and at least one display-connecting port 132.

Continuously referring to FIG. 3, and simultaneously referring to FIG. 4, which illustrates the exploded view of the removable host of the improved computer device, the removal host 12 described above is disposed in the accommodation portion 111 and includes: a host case 121, a plurality of electronic devices 122 and a pull rod 123, wherein the host case 121 has a base 1211 and a cover 1212, the host case 121 has a panel 1213, moreover, a power switch 1214 and a lock-switch 1215 are disposed on the panel 1213, wherein the lock-switch 1215 is used to interact with the lock-hole 112, and then the removable host 12 is locked inside of the accommodation portion 111; The cover 1212 is used to shelter the base 1211; The plurality of electronic devices are disposed on the base 1211 and constitute a computing system for processing, moreover, the electronic devices includes a first connection portion 1221, wherein the first connection portion 1221 is inserted into the host-connecting port 131 when the removable host 12 is placed into the accommodation portion 111; The pull rod 123 is pivotally connected to the host case 121 so that the host case 121 is easily to drawn from the accommodation portion 111 through the pull rod 123, and then the electronic devices are capable of being maintained.

Referring to FIG. 3, and concurrently referring to FIGS. 5A and 5B, which illustrate the stereo view of the first connection mechanism of the improved computer device, the first connection mechanism 14 is disposed on the housing 11 and includes: a first connection plate 142, a first pivotal connection member 143, a support shaft 144, and a second pivotal connection member 145, wherein the first connection plate 142 has a first connection card 141 for connecting the touchable display unit 15; The first pivotal connection member 143 is connected to the first connection plate 142; One end of the support shaft 144 is pivotally connected to the first pivotal connection member 143, so that the first connection plate 142 is capable of pivotally moved; The second pivotal connection member 145 is disposed on the housing 11, wherein the another end of the support shaft 144 is pivotally connected to the second pivotal connection member 145, and then the support shaft 144 is able to be pivotally removed.

Referring to FIG. 4, and simultaneously referring to FIGS. 6, and 7, which respectively illustrate the stereo view and the another stereo view of the touchable display unit of the improved computer device, the touchable display unit 15 is connected to the first connection mechanism 14 and has a second connection portion 151, which has a first aperture 1511 and a first connection port 1512, wherein the first aperture 1511 is used to take the first connection plate 142; the first connection port 1512 is disposed on the first aperture 1511 for connecting the first connection card 141, so that the touchable display unit 15 is electrically connected to the removable host 12 through the transmission interface unit 13; Moreover, four expansion ports 152 are respectively disposed on the four sides of the touchable display unit 15 so as to respectively connect an electronic device for increasing functions.

Referring to FIG. 6 and 7 again, the expansion ports 152 disposed on the sides of the touchable display unit 15 are able to be connect the electronic devices, and then the improved computer device 1 increases the functions thereof, as shown in FIG. 7, wherein a Wi-Fi transmission module 50 and a magnetic stripe reader (MSR) 70 are respectively connected to the expansion port 152 disposed on the left side and the right side of the touchable display unit 15, and a product information display 60 is connected to the expansion port 152 disposed on the top side of the touchable display unit 15; Moreover, in the embodiment according to this invention, the electronic devices used to connect to the expansion ports 152 also as follows: a hard disc, a RFID module, a Bluetooth module, an MSR and fingerprint module, and an MSR and iButton module; Besides, as shown in FIG. 7, the touchable display unit 15 further includes four connection port covers 153, which are used to wrap the expansion ports 152 when the expansion ports 152 without connecting the electronic devices.

Furthermore, referring to FIG. 8, which illustrates the stereo view of the improved computer device with two displays, a second connection mechanism 16 and a display unit 17 are added to the improved computer device 1 for increasing the functions thereof, so that the improved computer device 1 has two displays for simultaneously being operated. As shown in FIG. 8, wherein the second connection mechanism 16 is disposed on the housing 11 corresponding to the first connection mechanism 14 and includes: a support pillar 162 and a second display-connecting portion 162; The display unit 17 has a third connection portion 171 for connecting to the second display-connecting portion 162, so that the display unit 17 is able to electrically connect to the removable host 12 through the transmission interface unit 13; The display unit 17 can be a touch display for operating by a user, or being the product information display 60 for showing a product information and a calculated result.

Moreover, the improved computer device 1 according to present invention further has a second embodiment. Referring to FIGS. 9A and 9B, which respectively illustrate the stereo view and the exploded view of the second embodiment of the improved computer device according to present invention, wherein the second embodiment of the improved computer device 1 has the strong potential functions and includes: a housing 21, a transmission interface unit 23, a removable host 22, a first connection mechanism 24, a first touchable display unit 25, a second connection mechanism 26, a second touchable display unit 27, and a base stand 28, wherein the housing has an accommodation portion 211 in the inside thereof; The transmission interface unit 23 is disposed in the accommodation portion 211 so as to assist transmitting signal, moreover, the transmission interface unit 23 has a host-connecting port 231 and a display-connecting port 232;

Referring to FIG. 9B, and concurrently referring to FIG. 10, which illustrates the exploded view of the removable host of the second embodiment of the improved computer device, the removable host 22 described above is disposed in the accommodation portion 211 and includes: a host case 221, a plurality of electronic devices 222, and a pull rod 23, wherein the host case 221 has a base 2211 and a cover 2212, the base 2211 has a panel 2213 with a power switch 2214 and a lock-switch 2215, so that the removable host 22 is capable of being locked in the accommodation portion 211 by using the lock-switch 2215; The cover 2212 is used to shelter the base 2212; The plurality of electronic devices are disposed on the base 2211 and constitute the computing system for processing, wherein the electronic devices include a first connection portion 2221, which is able to insert the host-connecting port 231 when the removable host 22 is placed into the accommodation portion 211. The pull rod 223 is pivotally connected to the host case 221, and then the host case 221 is easily to be drawn from the accommodation portion 211 via the pull rod 223 so as to maintain or expand the electronic devices.

Continuously referring to FIG. 9B, and referring to FIG. 11, which illustrates the exploded view of the first connection mechanism of the second embodiment of the improved computer device according to the present invention, the first connection mechanism 24 of the second embodiment is disposed on the housing 21 and includes: a first connection plate 242, a first pivotal connection member 243 and two second pivotal connection member 244, wherein the first connection plate 242 has a first connection card 241 for connecting the first touchable display unit 25; the first pivotal connection member 243 is connected to the first connection plate 242; The two second pivotal connection member 244 are respectively connected to the two ends of the first pivotal connection member 243, so that the first connection plate 242 and the first pivotal connection member 243 are able to pivotally removed.

Referring to FIG. 9B, and simultaneously referring to FIGS. 12A and 12B, which illustrate the stereo view of the first touchable display unit of the second embodiment of the improved computer device, the first touchable display unit 25 is connected to the first connection mechanism 24 and has a second connection portion 251 with a first aperture 2511 and a first connection port 2512, wherein the first aperture 2511 is used to take the first connection plate 242; The first connection port 2512 is disposed on the first aperture 2511 and connects to the first connection card 241, so that the first touchable display unit 25 is able to electrically connect to the removable host 22 through the transmission interface unit 23; Moreover, four first expansion ports 252 are respectively disposed on four sides of the first touchable display unit 25 so as to respectively connect the electronic device for increasing functions.

Referring to FIGS. 12A and 12B again, the first expansion ports 252 disposed on the sides of the first touchable display unit 25 are used to be connect the electronic devices, and then the improved computer device 1 increases the functions thereof, as shown in FIG. 12B, wherein the Wi-Fi transmission module 50 and the magnetic stripe reader (MSR) 70 are respectively connected to the first expansion port 252 disposed on the left side and the right side of the first touchable display unit 25, and the product information display 60 is connected to the first expansion port 252 disposed on the top side of the first touchable display unit 25; Moreover, in the second embodiment according to this invention, the electronic devices used to connect to the first expansion ports 252 also as follows: the hard disc, the RFID module, the Bluetooth module, the MSR and fingerprint module, and the MSR and iButton module; Besides, as shown in FIG. 12A, the first touchable display unit 25 further includes four first connection portion covers 253, wherein the first connection portion covers 253 are used to wrap the first expansion ports 252 when the first expansion ports 252 without connecting the electronic devices.

Referring to FIG. 9B, and simultaneously referring to FIG. 13, which illustrates the exploded view of the second connection mechanism of the second embodiment of the improved computer device, the second connection mechanism 26 is disposed on the housing 21 corresponding to the first connection mechanism 24 and includes: a second connection plate 262, a third pivotal connection member 263 and two fourth third pivotal connection member 264, wherein the second connection plate 262 has a second connection card 261 for connecting to the second touchable display unit 27; The second pivotal connection member 263 is connected to the second connection plate 262; The two fourth pivotal connection member 264 are connected to the housing 21, and are further respectively connected to the two ends of the second pivotal connection member 263, so that the second connection plate 262 and the third pivotal connection member 263 can be pivotally moved.

Continuously referring to FIG. 9, and referring to FIG. 14, which illustrates the stereo view of the second touchable display unit of the second embodiment of the improved computer device, the second touchable display unit 27 is connected to the second connection mechanism 26 and has a third connection portion 271 with a second aperture 2711 and a second connection port 2712, wherein the second connection aperture 2711 is used to take the second connection plate 262; The second connection port 2712 is connected to the second connection card 261, so that the second touchable display unit 27 is able to electrically connect to the removable host 22 through the transmission interface unit 23; Moreover, in the second embodiment according to present invention, four second expansion ports 272 are respectively disposed on the four sides of the second touchable display unit 27 so as to respectively connect the electronic devices for increasing functions. The second touchable display unit 27 further includes four second connection port covers 273 the same as the first touchable display unit 25, wherein the second connection port covers 273 are able to shelter the second expansion ports when the second expansion ports without connecting the electronic devices. Besides, either being connected to the second expansion port 272, the product information display 60 can also being used to substitute the second touchable display unit 27 for showing the product information and the calculated result.

Referring to FIG. 9B again, the second embodiment is able to simultaneously be operated two displays comparing with the first embodiment and further includes the base stand 28, which is used to hold the housing 21, and then the improved computer device 1 becomes an upright state according to the demands of the different users.

Thus, the improved computer device according to the present invention has been described clearly. In summary, the present invention offers the following advantages:
1. the removable host and the touchable display unit are both modular design so as to facilitate being assembled and disassembled.
2. inheriting the above-mentioned advantage, the modular design of the removable host and the touchable display unit make maintaining the electronic devices and expanding the functions more easily.
3. the present invention includes the first embodiment and the second embodiment according to the demands of the users.

The above description is made on an embodiment of the present invention. However, this embodiment is not intended to limit scope of the present invention, and all equivalent implementations or alterations within the spirit of the present invention still fall within the scope of the present invention.

What is claimed is:

1. An improved computer device, comprising:
a housing, having an accommodation portion, wherein a lock-hole is disposed on the bottom surface of the accommodation portion;
a transmission interface unit, being disposed in the accommodation portion for assisting signal transmission and having a host-connecting port and at least one display-connecting port;
a removable host, being disposed in the accommodation portion and comprising:
a host case, having a base and a cover, wherein the base is sheltered by the cover;
a plurality of electronic devices, being disposed on the base and constituting a computing system for processing, the electronic devices having a first connection portion, wherein the first connection portion is inserted into the host-connecting port when the removable host is disposed into the accommodation portion; and
a pull rod, being pivotally connected to the host case, so that the host case is able to be drawn from the accommodation portion through the pull rod;
a first connection mechanism, being disposed on the housing and having a first connection card; and
a touchable display unit, being connected to the first connection mechanism and having a second connection portion connected to the first connection card, so that the touchable display unit is electrically connected to the removable host via the transmission interface unit, moreover, a plurality of expansion ports being disposed on the sides of the touchable display unit so as to respectively connect to an electronic device for increasing functions.

2. The improved computer device of claim 1, further comprising:
a second connection mechanism, being disposed on the housing corresponding to the first connection mechanism and having a support pillar and a second display-connecting portion; and
a display unit, being connected to the second display-connecting portion and having a third connection portion, wherein the third connection portion is connected to the second display-connecting portion, so that the display unit can electrically connect to the removable host through the transmission interface unit.

3. The improved computer device of claim 1, wherein the base comprises a panel with a power switch and a lock-switch, the lock-switch being used to interact with the lock-hole, and then the removable host is locked in the accommodation portion.

4. The improved computer device of claim 1, wherein the first connection mechanism further comprises:
a first connection plate, having the first connection card for connecting to the touchable display unit;
a first pivotal connection member, being connected to the first connection plate;
a support shaft, the one end of the support shaft being pivotally connected to the first pivotal connection member, so that the first plate is able to swing; and
a second pivotal connection member, being disposed on the housing, wherein the another end of the support shaft is pivotally connected to the second pivotal connection member, so that the support shaft is capable of swinging.

5. The improved computer device of claim 4, wherein the second connection portion further comprises:
a first aperture, being used to bear the first connection plate; and
a first connection port, being disposed on the first aperture and connecting to the first connection plate, so that the first connection port is electrically connected to the display-connecting port via the first connection card.

6. The improved computer device of claim 1, wherein the touchable display unit further comprises a plurality of connection port covers, which are used to shelter the expansion ports without the connection of the expansion ports and the electronic device.

7. The improved computer device of claim 1, wherein the electronic device is selected from the group consisting of: an RFID module, a Bluetooth module, a Wi-Fi transmission module, a product information display, a magnetic stripe reader (MSR), an MSR and fingerprint module, and an MSR and iButton module.

8. An improved computer device, comprising:
a housing, having an accommodation portion;
a transmission interface unit, being disposed in the accommodation portion for assisting signal transmission and having a host-connecting port and at least one display-connecting port;
a removable host, being disposed in the accommodation portion and comprising:
a host case, having a base and a cover, wherein the base is sheltered by the cover;
a plurality of electronic devices, being disposed on the base and constituting a computing system for processing, the electronic devices having a first connection portion, wherein the first connection portion is inserted into the host-connecting port when the removable host is disposed into the accommodation portion; and
a pull rod, being pivotally connected to the host case, so that the host case is capable of being drawn from the accommodation portion through the pull rod;
a first connection mechanism, being disposed on the housing and having a first connection card;
a first touchable display unit, being connected to the first connection mechanism and having a second connection portion connected to the first connection card, so that the first touchable display unit electrically is connected to the removable host via the transmission interface unit, moreover, a plurality of first expansion ports being disposed on the sides of the first touchable display unit so as to respectively connect to an electronic device for increasing functions;
a second connection mechanism, being disposed on the housing corresponding to the first connection mechanism and having a second connection plate; and
a second touchable display unit, being connected to the second connection mechanism and having a third connection portion connected to the second connection plate, so that the second touchable display unit is electrically connected to the removable host through the transmission interface unit, moreover, a plurality of second expansion ports being disposed on the sides of the second touchable display unit so as to respectively connect the electronic devices for increasing functions.

9. The improved computer device of claim 8, further comprising a base stand, being used to hold the housing.

10. The improved computer device of claim 8, wherein the base comprises a panel with a power switch and a lock-switch, the lock-switch being used to lock the removable host within the accommodation portion.

11. The improved computer device of claim 8, wherein the first connection mechanism further comprises:
a first connection plate, having the first connection card for connecting the first touchable display unit;
a first pivotal connection member, being connected to the first connection plate; and
two second pivotal connection member, being connected to the housing, wherein the two second pivotal connection member are respectively connected to the two ends of the first pivotal connection member, so that the first connection plate and the first pivotal connection member are able to swing.

12. The improved computer device of claim 11, wherein the second connection portion further comprises:
a first aperture, being used to bear the first connection plate; and
a first connection port, being disposed on the first aperture and connecting to the first connection card, so that the first connection port is electrically connected to the display-connecting port via the first connection card.

13. The improved computer device of claim 8, wherein the second connection mechanism further comprises:
a second connection plate, having the second connection card for connecting the second touchable display unit;
a third pivotal connection member, being connected to the second connection plate; and
two fourth pivotal connection member, being connected to the housing, wherein the two fourth pivotal connection members are respectively connected to the two ends of the third pivotal connection member, so that the second connection plate and the third pivotal connection member are able to swing.

14. The improved computer device of claim 13, wherein the third connection portion further comprises:
a second aperture, being used to bear the second connection plate; and
a second connection port, being disposed on the second aperture and connected to the second connection card, so that the second connection port is electrically connected to the display-connecting port via the second connection card.

15. The improved computer device of claim 8, wherein the first touchable display unit further comprises a plurality of first connection portion covers, which are used to shelter the first expansion ports without the connection of the first expansion ports and the electronic devices.

16. The improved computer device of claim 8, wherein the second touchable display unit further comprises a plurality of second expansion port covers, which are used to shelter the second expansion ports without the connection of the second expansion ports and the electronic devices.

17. The improved computer device of claim 8, wherein the electronic device is selected from the group consisting of: a hard disk, an RFID module, a Bluetooth module, a Wi-Fi transmission module, a product information display, a magnetic stripe reader (MSR), an MSR and fingerprint module, and an MSR and iButton module.

18. The improved computer device of claim 17, wherein the product information display is able to substitute the second touchable display unit.
